(19) United States
(12) Patent Application Publication
(10) Pub. No.: US 2016/0376851 A1
(43) Pub. Date: Dec. 29, 2016

(54) Device For The Connection of Rods For A Downhole Pumping Apparatus

(71) Applicant: Wm. Bruce Morrow, Santa Barbara, CA (US)

(72) Inventor: Wm. Bruce Morrow, Santa Barbara, CA (US)

(21) Appl. No.: 14/748,968

(22) Filed: Jun. 24, 2015

(51) Int. Cl. E21B 17/042; F16B 7/18

(52) U.S. Cl. CPC E21B 17/0426; F16B 7/182

(57) ABSTRACT

A device for connecting sucker or drive rods, consisting of a threaded coupling and like threaded pins of adjacent rods. The ends of the pins are equipped with dogs, or lugs, that interlock, firmly linking the rods torsionally. The coupling is threaded along one of the rod pins until the dogs, or lugs, are exposed, then engaging those exposed elements with dogs, or lugs, of the adjacent rod, and finally reversing the rotation of the female coupling so that it threads back over both rods' threaded pins, and covers the engaged dog clutch elements. The rods are connected torsionally via the engaged dogs, or lugs, with the coupling serving only to keep the dogs, or lugs, engaged and to carry the tensional load of the connection. Such a connection provides a stronger torsional link between rods than connections currently available. The connection also does not require the special make-up procedure of the current systems and cannot over-tighten or back off during operation.

The present invention relates to improvements in connections between the individual segments of a rod string for the rotational drive of a downhole pump used in production wells to retrieve and deliver to the surface production fluids from subterranean deposits.

### BACKGROUND OF INVENTION

### Field of the Invention

A common method of lifting fluid from an oil well, the progressive cavity pumping system, utilizes a string of steel rods attached to a progressive cavity pump at the bottom of the well, which are rotated by a drive mechanism at the surface to activate the pump. This string of rods is similar to that used in a beam, or sucker rod, pumping apparatus, sharing an identical method of connection between the individual sections of rod, but utilizes rotational, rather than reciprocating, motion to activate the downhole pump.

The type of connection between rod segments utilized in both sucker rod pumping systems and progressive pumping systems (as well as other rod rotational drive pumping systems) consists of threaded pins at the ends of the rod segments, that are joined via an internally threaded female coupling. The threaded pins of the two rods to be joined are screwed into the female coupling until the machined ends of the coupling are tightly made up against machined shoulders on the rods. This type of connection was developed for the sucker rod application, where the rod motion is reciprocation, and loads on the rods and rod connections are entirely tensional.

When the progressive cavity pump was developed, the widely available sucker rods were utilized for the rotating rod string to drive the downhole pump, despite the fact that the sucker rod connection was not designed to transmit the torsional loads of the progressive cavity pump drive. The existing system of joining rods for rotational drive functions satisfactorily when installed and operated properly, but remains the single greatest problem of the various rotational rod drive systems. The present invention addresses these problems with a new rod connection system that is stronger and much easier to install properly than the existing system and will be only slightly, if at all, more costly than the existing system.

### OVERVIEW OF THE PRIOR ART

The existing, prior art system for joining the individual rods that make up the rod string used to rotationally drive a downhole pump consists of threaded pins at the ends of the rods connected via a female threaded coupling. The rods are equipped with machined shoulders near the threaded pins, and the rods are screwed into the coupling until the rod shoulders make up tightly against the ends of the coupling. The torsional force of one rod is transmitted to the adjacent rod through the coupling via the friction between the machined surfaces of the rod shoulders and the ends of the coupling.

The principal problem of the existing rod connection for rotating rod systems like the progressive cavity pumps, is over tightening of the connection during operation, resulting in failure of either the threaded pin or coupling. This over tightening occurs because of grease or dirt contamination lubricating the machined surfaces of the rod shoulders or coupling ends, allowing the connection to gradually tighten until either the pin or coupling fails. The surfaces of the rod shoulders and coupling ends must be absolutely clean, dry and free of any contamination, so that when the threaded connection is made up to the prescribed torque, the surfaces are “locked” in place by static friction. This cleanliness requirement is a significant burden during rod string installation, as making sure that every connected surface is completely clean, in the naturally oily and dirty environment of a well service rig, requires constant vigilance. There only needs to be one less-than-clean connection out of hundreds to result in a rod string failure.

Another problem with the existing rod connection for rotating rod systems, is the threads of the connection are under both torsional and tensional loading, as the coupling must both transmit torsional load to the coupling, as well as carry the tensional loading due to rod weight. This problem is, at its worst, at or near the surface, as the tension on the rod pins is maximized due to the weight of the rods hanging below, and the rod pins can fail, particularly during start-up torque surges.

A further, but lesser, problem with the existing rod connection system is the backing-off separation of the rods. Since the existing connection consists typically of right-hand threaded members, back spinning of the rod string, which will occur with progressive cavity pumps whenever the surface drive is shut off, can result in the unscrewing of one or more of the connections, requiring a costly well service to reconnect the rods.

The present invention eliminates all of these problems with the existing rod connections by physically linking adjacent rods for torsional load transmission via a dog clutch, or similar torsional connection, between the rods. The threaded coupling provides only the tensional connection between the rods.

A preliminary search of the patent literature was made and the following listed patents pertaining to the present invention are believed to be relevant:

Journeay, U.S. Pat. No. 1,547,759 (November 1930)

Mefferd, U.S. Pat. No. 4,821,818 (April 1989)

Hughes, U.S. Pat. No. 5,950,744 (September 1999)

Xin et al., U.S. Patent App. 2012/0088588 A1 (Pub. April 2012)

Journeay U.S. Pat. No. 1,547,759 describes a system to join sections of drill pipe, consisting of interlocking tongues and slots in the ends of the drill pipe, which are connected via a threaded sleeve, with a mechanical ratchet mechanism to prevent unthreading of the sleeve. The Journeay patent is specifically for joining tubular devices, which are required to provide a channel for flow of liquids during the process of well drilling, where the present invention is for the connection of solid rods entirely for the torsional drive of a downhole pump. Also, the principal function of the Journeay patent was to provide a drill string connection that would not unscrew during drilling operations, whereas the principal objective of the present invention is to prevent the drive rods from over-tightening, the opposite of unscrewing.

Mefferd U.S. Pat. No. 4,821,818 describes a system of connecting tubular members used an auger drilling that is similar to Journeay in the use of a tongue and groove connection. However, Mefferd connects the pipes via cylindrical collars, rather than a threaded sleeve, as in the case of Journeay. Like Journeay, the Mefferd patent is for joining tubular members, which are required to provide a channel for flow of liquids.

Hughes U.S. Pat. No. 5,950,744 describes a system of joining drill pipe, or tubing, that provides for a unique angular orientation of the entire string of pipe or tubing. The system is similar to Journeay in the use of a tongue and groove connection between the pipes, joined via a threaded sleeve, but with irregular spaced tongues and grooves, so that the pipes can be joined in only one orientation. Like Journeay and Mefferd, the system is for the joining of tubular members required to provide a channel of flow of fluids, and, in the case of Hughes, a passage for the running of instruments or other devices into a well.

Neither Journeay's nor Hughes' invention has found use in oil field operations, for two reasons. First, the tongue and groove connection between the pipes, as shown in the patent descriptions, would have less than half the torsional strength of the drill pipe, requiring a large increase in wall thickness within the connection to increase the strength to the required level. This would severely reduce the inside diameter of the drill pipe at each connection. Also, the threaded connection between the sleeve and the pipe ends would not provide the level of pressure seal required by drill pipe or tubing, where there can frequently be several thousands of pounds of pressure differential between the inside of the drill pipe or tubing, and the outside of the pipe or tubing.

The present invention does not suffer from either of these problems. Rod string connections are typically significantly larger in diameter than the rods, so there is ample material to make a torsional connection that is actually stronger than the torsional strength of the rods themselves. Also, since the rods are solid and are not required to provide a channel for high pressure fluid flow, the threaded connection need not provide a pressure seal, and can be designed purely for tensional strength.

Xin et al. patent publication 2012/0088588 A1 describes a rod connection involving different thread sizes on the adjacent rods, a wedge and groove torsional link between the joined rods, with the link being held in place via a complex coupling consisting of a partially threaded outer sleeve, a two piece inner threaded sleeve and an outer lock nut.

This rather complex system differs significantly from the present invention in the way the rods are coupled for tension, the connection make-up procedure, and the configuration of the torsion carrying members.

In the current invention, the rod tension is carried by the threaded ends of the adjacent rods via a single piece, internally threaded coupling, providing a much simpler connection make-up procedure. Also, instead of a wedge-groove torsional connection between rods, the rod ends of the present invention have identical dog clutch elements. The bearing surfaces of the dogs are parallel to the rod axis, so torsional loading causes no appreciable axial forces, and the coupling carries the rod tension only. This dog clutch configuration provides a connection with significantly greater torsional strength than the wedge-groove connection, as the dog clutch components are loaded purely in shear, where the wedge-groove connection results in significant bending loading of the groove members. Locking of the coupling of the present invention is affected via simple tapered threads over a short portion of one of the threaded rod ends, as the torque in the rod string has no appreciable affect on the coupling.

### A BRIEF DESCRIPTION OF THE DRAWINGS

FIG. 1 shows the threaded pin end of a conventional sucker, or drive rod, in position for an existing type connection to an adjacent rod;

FIG. 2 shows the threaded pin end of the adjacent sucker, or drive rod, in position for connection;

FIG. 3 shows a side view of a female internally threaded coupling;

FIG. 4 shows a semitransparent view of the FIG. 3. coupling, showing the internal female threads;

FIG. 5 shows the FIGS. 1 and 2 rod ends, partially connected via the FIG. 3 threaded coupling, where the coupling has been made up finger tight on the FIG. 1 threaded pin, and the FIG. 2 threaded pin is partially screwed into the coupling;

FIG. 6 shows the connection between the FIG. 1 and FIG. 2 rods completely made up, with a cut-away through the coupling showing the relative position of the threaded pins;

FIG. 7 shows a side view of the end of a rod of the present invention, in position for connection to an adjacent rod, showing the threaded pin and a dog clutch element;

FIG. 8 shows a side view of the end of the adjacent rod of the present invention in position for connection, showing the threaded pin and a side view of the dog clutch elements, rotated 90° from the dog clutch element of the adjacent rod shown in FIG. 7;

FIG. 9 is an end view of the FIG. 7 rod, showing the position of the dog clutch elements;

FIG. 10 is an end view of the FIG. 8 rod, showing the position of the dog clutch elements oriented to mate with the dog clutch elements of FIG. 9.

FIG. 11 a side view of the internally threaded female coupling;

FIG. 12 is a semitransparent side view of the threaded female coupling of the present invention, showing the internal threads extending uninterrupted through the entire internal bore;

FIG. 13 shows the female coupling partially threaded on to the threaded pin of the FIG. 8 rod end;

FIG. 14 shows the female coupling threaded further on to the threaded pin of the FIG. 8 rod end, with the dog clutch elements exposed;

FIG. 15 shows the adjacent rods to be connected, with the FIG. 8 rod end with the threaded coupling in the position shown in FIG. 14;

FIG. 16 shows the adjacent rods with their dog elements partially engaged;

FIG. 17 shows the adjacent rods with their dog elements completely engaged;

FIG. 18 shows the rod ends with fully engaged dog elements, with the threaded female coupling partially threaded across the engaged dogs;

FIG. 19 shows the connection completely made up, with the female coupling fully threaded across the engaged dog clutch elements;

FIG. 20 is similar to FIG. 15, with one of the dog clutch elements on the FIG. 7 rod end and the space between the dog clutch elements of the FIG. 8 rod end, highlighted with white paint or stain;

FIG. 21 shows the rod end of FIG. 20 partially engaged;

FIG. 22 is an end view of a rod with dog clutch elements of unequal angular size and spacing; and,

FIG. 23 is an end view of the adjacent rod with dog clutch elements of unequal angular size and spacing.

### DETAILED DESCRIPTION OF PREFERRED EMBODIMENT

To appreciate the benefits of the present invention compared to the existing rod connection method, the details and dynamics of the existing system should be examined.

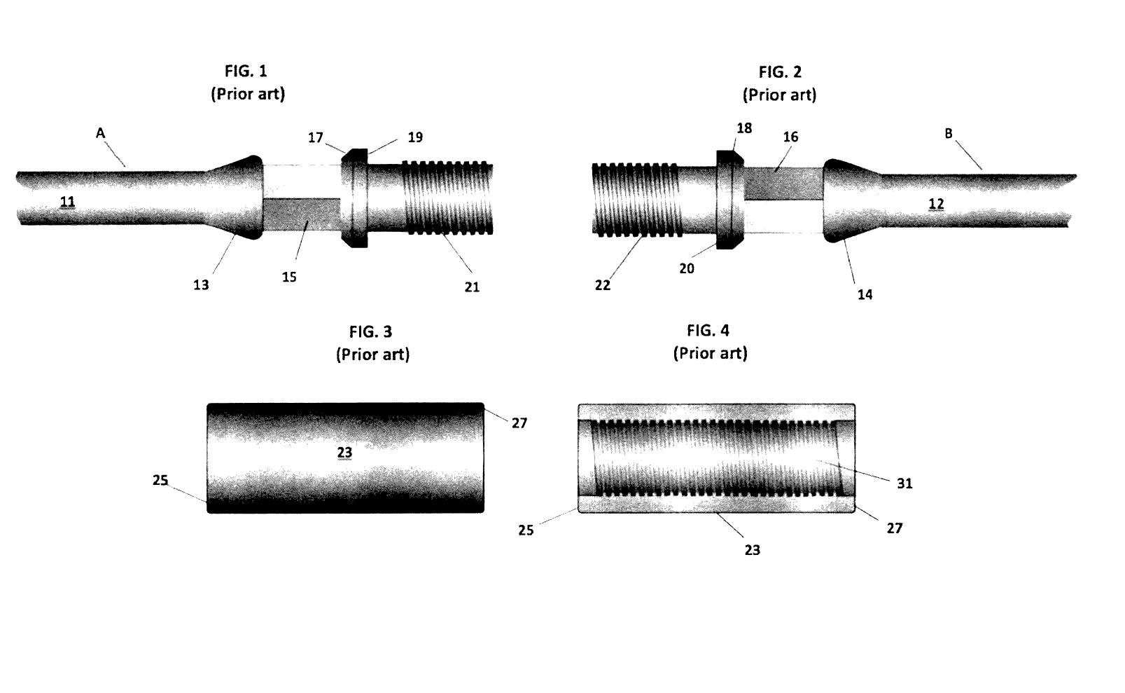

Sucker rods and drive rods used in the petroleum industry are usually 25 feet or 30 feet long. Both ends of each rod are identical and configured similar to that shown in FIGS. 1 and 2. FIGS. 1 and 2 show the ends of two adjacent sucker, or drive rods A and B, respectively, in relative position to be connected. Referring to FIG. 1, at the end of the rod body 11 is the coupling assembly, consisting of the transition flare 13, the wrench flat 15, the rod shoulder 17 with the machined surface 19 facing the threaded rod pin 21. Note that the threads of the threaded rod pin 21 are right-hand, as is the norm in the petroleum industry. The adjacent rod, shown as FIG. 2, has the same components of the coupling assembly. That is, at the end of the rod body 12 is the coupling assembly, consisting of the transition flare 14, the wrench flat 16, the rod shoulder 18 with the machined surface 20 facing the threaded rod pin 22. Note that the threads of the threaded rod pin 20 are also right-hand.

The two rods A and B are shown in FIG. 1 and FIG. 2 in relative position to be joined via an internally threaded female coupling 23, shown in side-view in FIG. 3. Both ends of the internally threaded female coupling 23 are machined flat surfaces 25 and 27, and are designed to bear against the machined surfaces 19 and 20 of the rod shoulders 17 and 18 when the adjacent rods A and B are connected. The internal threads of the internally threaded female coupling 23, shown as 29 and 31, are shown in FIG. 4. Note that both internal threads 29 and 31 are right-hand threads to mate with the right-hand threads of the threaded rod pins 21 and 22, respectively.

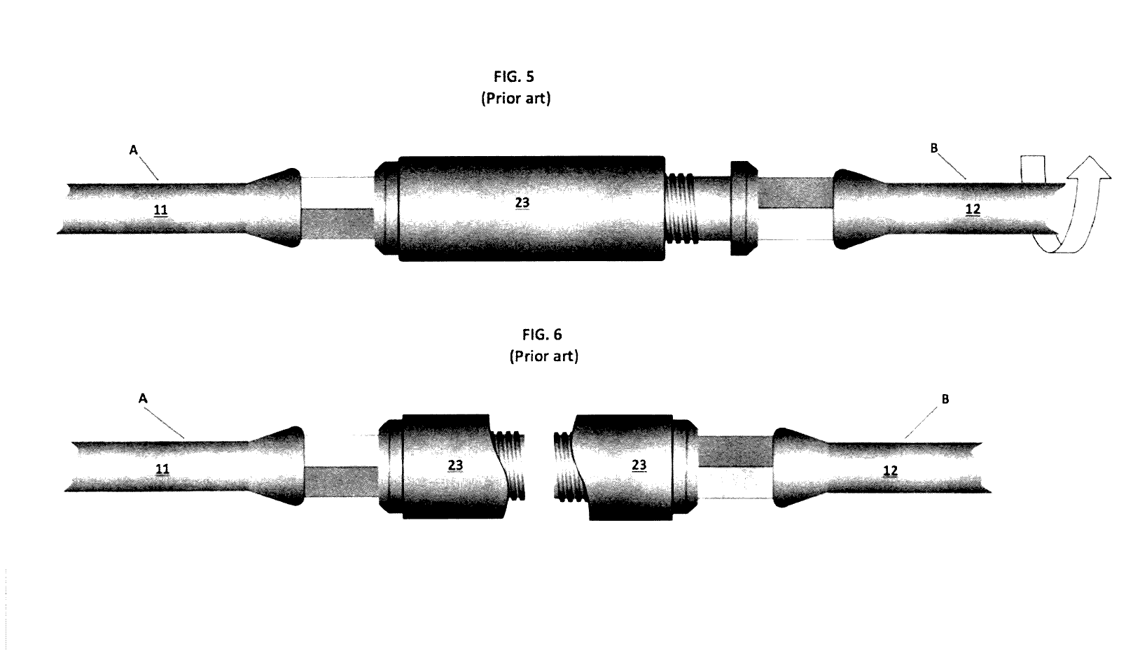

The connection between the two rods is affected by first screwing internally threaded female coupling 23 on to the threaded rod pin 21 of the FIG. 1. rod until hand-tight, then screwing the adjacent FIG. 2 rod into the internally threaded female coupling 23, as shown in FIG. 5. Once the FIG. 2 rod is fully threaded into internally threaded female coupling 23, the two rods are then torqued to a desired value, and the connection is complete, as seen in FIG. 6. FIG. 6 also shows, via a cut-away of the internally threaded female coupling 23, the relative positions of the threaded rod pins 21 and 22 of the joined rods. Note that they are not in physical contact with one another.

As seen in FIG. 6, the threaded rod pins 21 and 22 are not in direct physical contact. The only connection between the rods for torque transmission is via the internally threaded female coupling 23. Internally threaded female coupling 23 is not fixedly connected to either rod or through another mechanical means like a spline or other toothed connection. The only effective torsional connection internally threaded female coupling 23 has with either rod is via the friction between the machined flat surface ends 25 and 27 of the internally threaded female coupling 23, and the machined surfaces 19 and 20 of the rod shoulders 17 and 18, respectively. This frictional connection is only effective if the machined flat surfaces 25 and 27, and 19 and 20, are completely clean and dry, so that the make-up of the connection results in a “locked” condition, held in place by static friction between the aforesaid machined surfaces, that is greater than any expected torque in the rod string during operation.

Threaded connections, such as that shown in FIG. 6, with the aforesaid machined flat surfaces 25 and 27, and machined surfaces 19 and 20, that are less than perfectly clean and dry, are prone to gradually tighten during operation, due particularly to torque surges during start-up. This tightening can eventually cause the pin threads to fail in sheer, or the pin body to fail in tension. Less than clean connections also could loosen and back off during backspin when the system is shut down. All of these attendant problems of the existing rod connection, when used in a rotational drive system, can be eliminated by utilizing the present invention.

The most serious problem of the existing system is that the rods are not physically connected for torsion, except via the friction between the internally threaded female coupling 23 and the rod shoulders 17 and 18. A better configuration would be to have a mechanical, torsional, connection between the rod ends. However, such a mechanical connection requires the two rods to remain rotationally fixed relative to one another when connected, so utilizing the existing right hand threaded pin-coupling connection method is not feasible. To make up such a connection, the two rods must rotate relative to one another, and if they are mechanically, torsionally connected, this relative rotation is not possible. The present invention overcomes this problem, as described by the following.

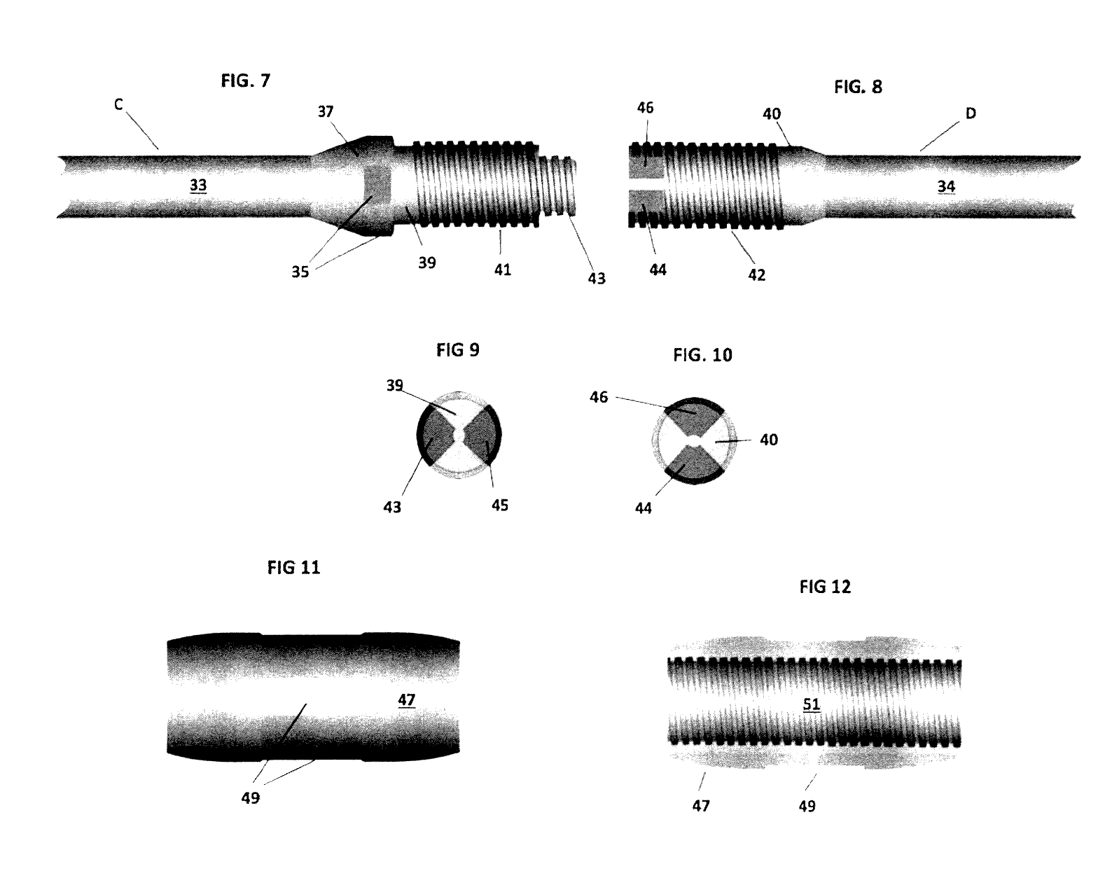

FIGS. 7 and 8, the adjacent ends of two rods show the ends of two adjacent drive rods, C and D, respectively, in relative position to be connected. The rod C of FIG. 7 has a rod body 33 and rod shoulder 37 with wrench flats 35 machined, or forged, on to the surface of rod shoulder 37. Rod pin 39 is equipped with right-hand external threads 41. Dog clutch elements 43 and 45 (45 not visible in this view) are machined, forged, or otherwise formed, into the end of rod pin 39. The dog clutch elements 43 and 45 are equipped with partial external threads of the same specification as right-hand threads 41. The rod D of FIG. 8 has a rod body 34, and rod pin 40 is equipped with right-hand external threads 42. Right-hand threads 42 are of identical specification as right-hand threads 41. Dog clutch elements 44 and 46 are machined, or forged, into the end of rod pin 40. The dog clutch elements 44 and 46 are equipped with partial external threads of the same specification as right-hand threads 42. Unlike the end of rod C shown in the FIG. 7 rod, the end of rod D shown in FIG. 8 has no shoulder or wrench flats, with threaded rod pin 40 tapering to the same diameter as the rod body 34. Note that the opposite end of rod C is identical to the rod D end shown in FIG. 8. Likewise, the opposite end of rod D is identical to the rod C end shown in FIG. 7.

The dog clutch elements 43, 45 and 44, 46, shown in FIGS. 7 and 8, respectively, are machined, or forged, steel lugs with the quarter circle (90°) cross-sectional shape, with each rod having two dogs 180° apart, as seen in the end views of the rod ends shown as FIGS. 9 and 10. The dog clutch elements 43 and 45 of the FIG. 7 rod, and the dog clutch elements 44 and 46 of the FIG. 8 rod are configured to interlock and engage snugly together, as described below, forming a mechanical torsional connection between the rods that is as strong as the torsional limit of the rod body 33 and 34.

FIG. 11 shows, in side view, the internally threaded female coupling 47, with shallow wrench flats 49 machined into its outer surface. FIG. 12 shows female coupling 47 in a semitransparent view showing the right-hand internal threads 51 machined into the inner surface of the inner bore and extending uninterrupted for the entire length of the female coupling 47. The right-hand internal threads 51 mate with the right-hand external threads of 41 and 42.

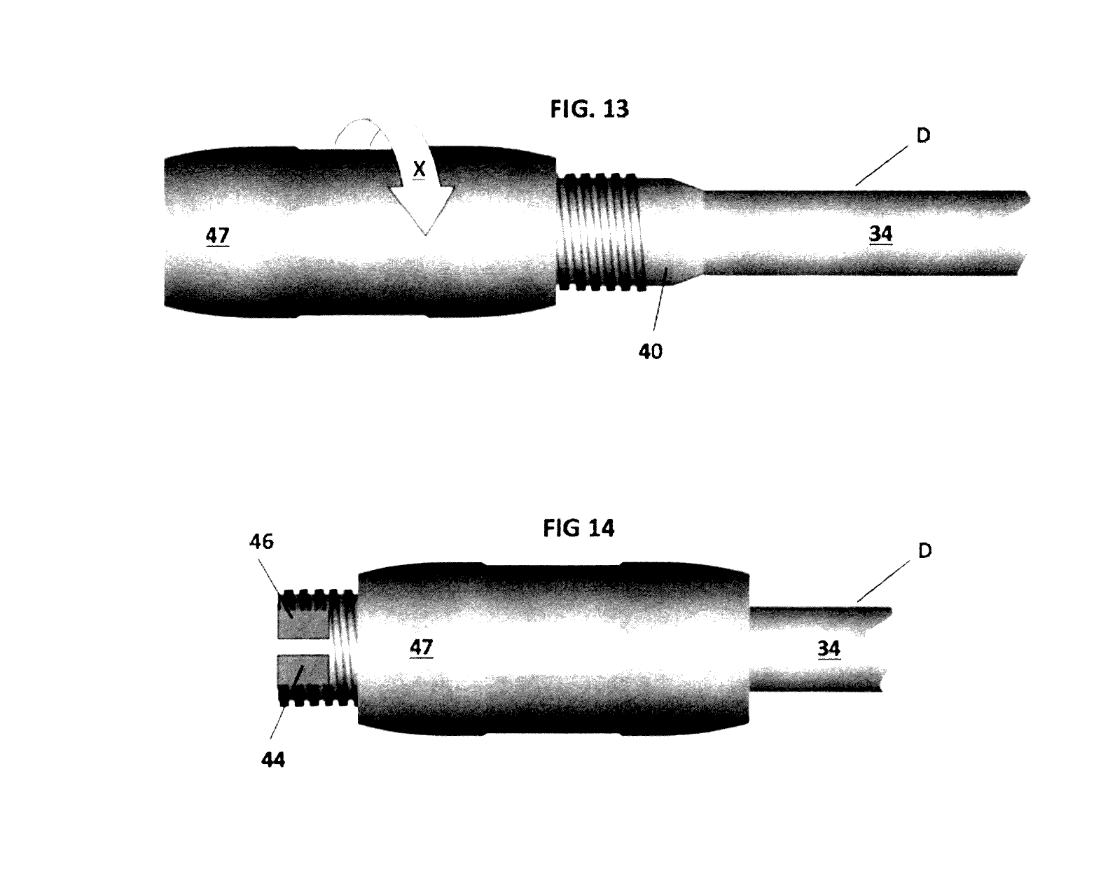

FIG. 13 shows the end of rod D with female coupling 47 partially threaded onto threaded rod pin 40, arrow “X” showing the direction of rotation of female coupling 47. FIG. 14 shows the end of rod D with female coupling 47 threaded further along rod pin 40, exposing dog clutch elements 44 and 46. The outer diameter of rod pin 40 is slightly less than the inner diameter of the internal threads 51 of female coupling 47, so that the female coupling 47 can pass freely along the unthreaded portion of the rod pin 40.

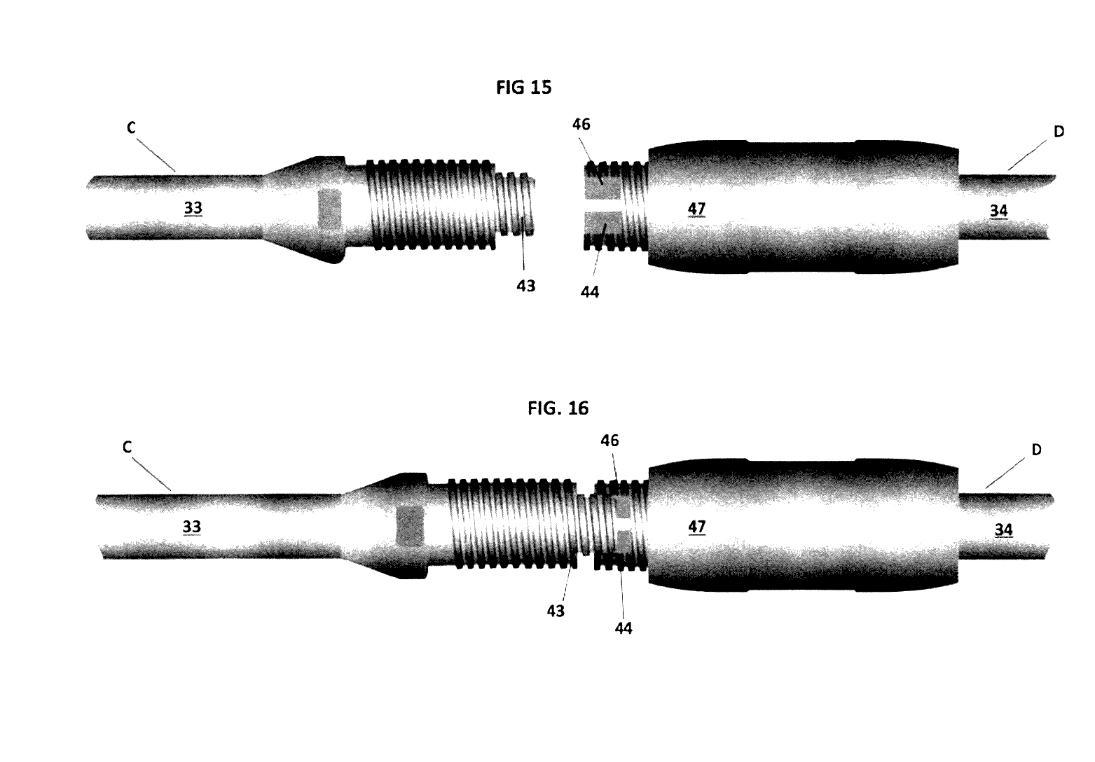

FIG. 15 shows rods C and D, positioned to be connected with female coupling 47 threaded along pin 40, exposing dog clutch elements 44 and 46 of rod D, in preparation for mating with dog clutch elements 43 and 45 of rod C.

FIG. 16 shows rods C and D with the dog clutch elements 43 and 45 (not shown) of rod C in partial engagement with the dog clutch elements 44 and 46 of rod D.

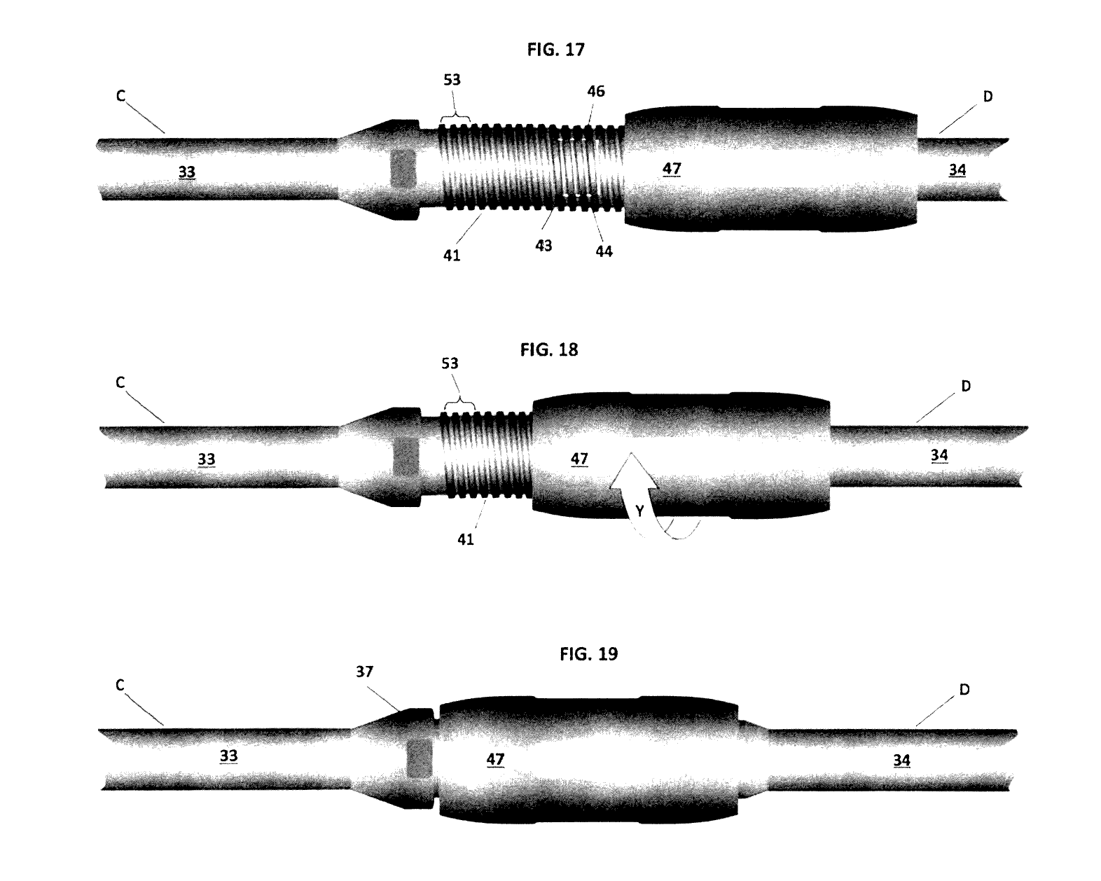

FIG. 17 shows rods C and D with the dog clutch elements 43 and 45 (not shown) of rod C in complete engagement with the dog clutch elements 44 and 46 of rod D. Also shown are threads 53, which are tapered, so that female coupling 47 is rotationally tightly held when made up over these threads.

FIG. 18 shows rods C and D with the dog clutch elements of rods C and D in complete engagement and female coupling 47 partially threaded back over the engaged dog clutch elements. The rotational direction of female coupling 47 is shown by arrow “Y”.

FIG. 19 shows the connection completely made up, with female coupling 47 threaded over tapered threads 53. The dog clutch elements of rods C and D are fully engaged and held in axial position firmly by the female coupling 47.

Once the dog clutch elements are fully engaged, the now connected rods cannot rotate relative to one another, and the connection is secure. The only way it can come apart is if the female coupling 47 is unscrewed. Rotation of the rod string has no effect on the integrity of the coupling threaded connection with the rods, as the torque in the system is transmitted entirely via the dog clutch connection between the rods. The female coupling 47 has only to carry the tensional load of the rod weight. Only a minor amount of torque is required to make up this connection, as there is no required friction between components to transmit torque.

In the forgoing embodiment, the dog clutch elements 43 and 45 of rod C and 44 and 46 of rod D, have a cross-sectional angular size of 90° and are spaced 180° apart, as seen in FIGS. 9 and 10. Since the dog clutch elements are symmetrical, they can be engaged in two ways, rotationally 180° apart. If the dog clutch elements are fully engaged, the threads of the adjacent pins will match for only one of the two rotational orientations, with the alternative orientation resulting in a mismatch between the adjacent engaged dogs equal to one half of the thread lead. Attempting to make up the connection in this circumstance, with the threads mismatched and the dog clutch elements completely engaged, would result in cross threading.

In the practical world of oil field operations, it would be beneficial if the rod connection process did not have the risk of damaging the threaded components of the rods due to mismatched engagement of the dog clutch. There are several ways this risk of incorrect assembly could be eliminated or greatly reduce.

For the symmetrical two-element dog clutch connection described above, a double-start thread configuration could be utilized. Double-start threads are two independent sets of parallel threads cut into the rod pins, with two thread-entry points 180° apart. The female coupling would be similarly threaded. Such a configuration would allow proper match-up of threads in the two-element dog clutch configuration no matter which of the two possible options of engagement was attempted. If a symmetrical three-element dog clutch connection were used, configured similarly to the two-element dog clutch connection detailed above, a triple-start threading scheme would allow thread match in any of the three potential angular orientations the dog clutch assembly could be engaged in.

The practical limit to the number of dog clutch elements, in a dog clutch-type connection is three. Dog clutches of two and three elements will have perfect load sharing among the elements. A four or more-element dog clutch will have guaranteed load sharing between only two of the elements, with partial loading of some of the others. This uneven loading will result in excess stress on the loaded elements and possible premature failure.

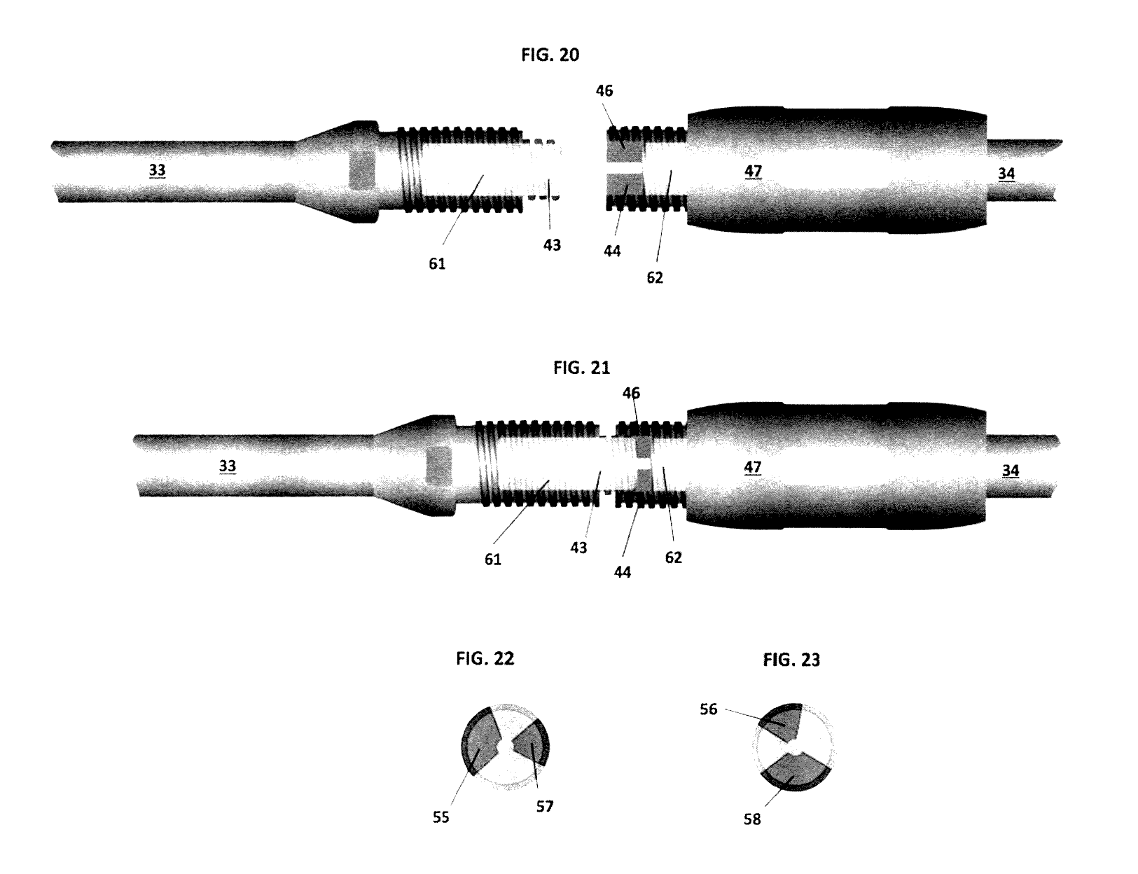

The simplest alternative to prevent improper thread match-up of a symmetrical dog clutch assembly, similar to that shown in FIGS. 7-19, and one that would allow the use of conventional single-start threading, would consist of marking with paint, stain or other means one of the elements of the dog clutch assembly of one of the rods and one of the spaces between elements of the dog clutch assembly on the adjacent rod, to indicate how the adjacent dog clutch assemblies are to be engaged to allow matched threading. This is shown in FIGS. 20 and 21, where element 43 is marked by the band of white paint 61, and the mating space between elements 44 and 46 is also marked by band of white paint 62. This scheme would work also with connections consisting of dog clutches with more than two elements.

As a further alternative, and one that would also allow the use of single-start threading, the dog clutch elements could be machined in unequal angular size, and spaced such that they can be engaged in only one rotational orientation, an unsymmetrical dog clutch configuration. FIGS. 22 and 23, in a similar fashion to FIGS. 9 and 10, show an end view of adjacent rods prior to engagement, with rod pins machined with an unsymmetrical two element dog clutch configuration. Although both ends of every rod would be configured identically, when one rod is facing the other for connection, the unsymmetrical dog clutch elements will engage perfectly, and in only one rotational position, assuring correct thread match-up. The same approach of unequal sized, unequally spaced elements could be used for dog clutches of more than two elements.

The disadvantage of the asymmetrical dog clutch configuration is a reduction in connection torsional strength compared to the symmetrical configuration. That is, the element that is reduced in size, 57 in FIG. 22 for example, will have reduced shear strength proportional to its reduced cross-sectional area, compared to the element of the symmetrical configuration. Since both lobes of a two-element dog clutch are loaded equally, the connection is only as strong as the weaker element, so the overall connection has a reduced torsional strength in the same proportion. The same problem exists for an asymmetrical three-element dog clutch.

In all of the forgoing connection schemes, the female coupling 47 need not be made up with appreciable torque, and there may be circumstances where, through vibration or rubbing against the inner tubing wall, the female coupling 47 may begin to unscrew if not restrained somehow. To be completely sure that the female coupling 47 remains firmly made up with the threaded rod pins 39 and 40, the threaded rod pin 39 would be cut with a tapered thread 53 over the last few threads, so as to require some nominal torque to make up the connection between the female coupling 47 and the threaded rod pin 39. This nominal torque would serve to keep the female coupling 47 from backing off in every circumstance. There are several other well known methods to lock threaded connections, and it is envisioned that any one or more of these alternative methods could be utilized in the present invention to prevent the female coupling 47 becoming inadvertently disconnected from the threaded rod pin 39.

It will be appreciated by those skilled in the art, upon reading this detailed description, one may think of some other variations in structure and form to torsionally connect the adjacent rods. Such variations are within the contemplation of the invention as described and claimed in the following:

1. A coupling device to axially connect the multiple rods of a drive rod string, with each individual connection between two adjacent rods consisting of:
a cylindrical coupling, said cylindrical coupling having an internal bore aligned and centered along the principal axis of said cylindrical coupling, said bore having threads cut into the internal surface of said bore, said threads extending the entire axial length of said bore;
an externally threaded cylindrical pin at both ends of said adjacent rods, said pin being integral with said rod, and having a principal axis collinear with the principal axis of said rod, said external thread having the same diameter, pitch and lead as the said internal thread of said bore of said cylindrical coupling;
multiple teeth, lugs, or dogs, machined, forged, or otherwise formed into the end of each said threaded pin, said teeth, lugs, or dogs, configured to engage and tightly interlock with the teeth, lugs, or dogs, of said threaded pin of said adjacent rod to torsionally connect said two rods end to end, when said teeth, lugs, or dogs, are engaged;
said cylindrical coupling threaded onto said threaded pin of one said adjacent rod, and rotated to move said coupling along said pin, said rotation continuing until said dogs at the end of said pin protrude beyond the end of said coupling;
said rod with said cylindrical coupling axially aligned with said adjacent rod;
said adjacent rods axially positioned such that said teeth or dogs of said rods completely engage and interlock with one another;
said cylindrical coupling rotated to move said coupling back toward said adjacent rod, said rotation continuing until said engaged teeth or dogs of said two adjacent rods are entirely within said internal bore of said coupling.

2. A coupling device of claim 1, wherein two teeth, lugs, or dogs, are machined, forged, or otherwise formed, into the end of each said threaded pin, said two teeth, lugs, or dogs, configured to engage and tightly interlock with the two teeth, lugs, or dogs, of said threaded pin of said adjacent rod to torsionally connect said two rods end to end, when said two teeth, lugs, or dogs, are engaged;
wherein each said two teeth, lugs or dogs has a radial cross-section in the shape of a segment of a circle with an included angle of 90°, the adjacent faces of said two teeth, lugs or dogs being spaced 90° apart on said end of said threaded pin.

3. A coupling device of claim 2, wherein said threads of said threaded pin are of a double-start configuration;
wherein the internal threads of said cylindrical coupling are also of the double-start configuration, with the same diameter, pitch and lead as the double-start threads of said threaded pin.

4. A coupling device of claim 1, wherein three teeth, lugs, or dogs, are machined, forged, or otherwise formed, into the end of each said threaded pin, said two teeth, lugs, or dogs, configured to engage and tightly interlock with the three teeth, lugs, or dogs, of said threaded pin of said adjacent rod to torsionally connect the said two rods end to end, when said three teeth, lugs, or dogs, are engaged;
wherein each said three teeth, lugs or dogs has a radial cross-section in the shape of a segment of a circle with an included angle of 60°, the adjacent faces of said three teeth, lugs or dogs being spaced 60° apart on said end of said threaded pin.

5. A coupling device of claim 4, wherein said threads of said threaded pin are of the triple-start configuration;
wherein the internal threads of said cylindrical coupling are also of the triple-start configuration, with the same diameter, pitch and lead as the triple-start threads of said threaded pin.

6. A coupling device of claim 1, wherein two teeth, lugs, or dogs, are machined, forged, or otherwise formed, into the end of each said threaded pin, said two teeth, lugs, or dogs, configured to engage and tightly interlock with the two teeth, lugs, or dogs, of said threaded pin of said adjacent rod to torsionally connect said two rods end to end, when said two teeth, lugs, or dogs, are engaged;
wherein each said two teeth, lugs, or dogs, has a radial cross-section in the shape of a segment of a circle, each of the two said teeth, lugs, or dogs, having a different included angle;
wherein the sum of the said included angles of said two teeth, lugs, or dogs, is 180°.

7. A coupling device of claim 1, wherein three teeth, lugs, or dogs, are machined, forged, or otherwise formed, into the end of each said threaded pin, said three teeth, lugs, or dogs, configured to engage and tightly interlock with the three teeth, lugs, or dogs, of said threaded pin of said adjacent rod to torsionally connect said two rods end to end, when said three teeth, lugs, or dogs, are engaged;
wherein each said three teeth, lugs, or dogs, has a radial cross-section in the shape of a segment of a circle, two of the said teeth, lugs, or dogs, having the same included angle, and the third tooth, lug, or dog, having an included angle different from that of the said two teeth, lugs, or dogs, having the same included angle;
wherein the sum of the said included angles of said three teeth, lugs, or, dogs is 180°.

8. A coupling device of claim 1, wherein the external surface or a portion of external threads of one or both of said rod pins is configured, or equipped with a device, to create friction between said threaded cylindrical coupling and said threaded rod pins, so that the rotation of said coupling during the make-up of the connection between adjacent rods requires a predetermined amount of torque.
